(19) United States
(12) Patent Application Publication
(10) Pub. No.: US 2009/0112381 A1
(43) Pub. Date: Apr. 30, 2009

(54) Method and apparatus for a crash survivable flight data recorder

(76) Inventors: Daniel J. Schwinn, Weston, MA (US); Steven W. Jacobson, Millbury, MA (US); Joseph Weihs, Arlington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/978,837

(22) Filed: Oct. 30, 2007

(51) Int. Cl. G06F 19/00

(52) U.S. Cl. 701/14; 701/35

(57) ABSTRACT

Common practice in the aviation industry is to place a single Flight Data Recorder (FDR) in an aircraft for the purpose of aiding an investigation of an aircraft accident or incident. In contrast, a system employing ‘an example’ embodiment of the invention uses multiple flight data recorders by having a primary node or first FDR, and one or more secondary nodes or one or more additional FDRs configured to store flight data. Each FDR is placed in a different location so as to ensure backup of the recorded and stored data. In this way, the invention system provides redundancy of information for an aircraft accident or incident and more reliable data storage.

### BACKGROUND OF THE INVENTION

A Flight Data Recorder (FDR) is typically a recorder placed in an aircraft for the purpose of facilitating the investigation of an aircraft accident or incident. The flight data recorder is designed to record the operating data from the aircraft's systems. FIG. 1 shows a prior art representation of an aircraft 100 having a single FDR. In particular, FIG. 1 shows a FDR 105 at the rear of the aircraft 100. The FDR 105 is capable of surviving the conditions typically encountered during a severe aircraft accident. More specifically, FDRs are typically specified to withstand an impact of 3600 g and temperatures of over 1,000° C. Although FDRs are remarkably durable they are prone to damage as well.

Today's governmental agencies, such as the Federal Aviation Administration (FAA) have additional requirements for aircraft safety. For example, commercial airlines using Flight Data Recorders (FDRs) are to record at least eighty-eight parameters. Examples of these parameters include: time, pressure altitude, airspeed, vertical acceleration, magnetic heading, control-column position, rudder-pedal position, control-wheel position, horizontal stabilizer, and fuel flow. By recording respective values of these parameters to an FDR and later retrieving the parameters values allows the FAA or other user to monitor aircraft accidents and incidents.

In the event of a flight incident, an FAA or other operator can review the FDR recorded parameter values and attempt to determine the cause of the flight incident. In some cases, however, the FDR is damaged beyond repair or can not be located. Thus, the operator is unable to review the recorded parameter values in the FDR and as such can not to determine a cause or a probable cause for the accident or incident.

### SUMMARY OF THE INVENTION

The present invention relates to using multiple flight data recorders in an aircraft where the FDRs are placed so as to use existing avionics processors. As a result, storage and networking requirements are lower, there is higher reliability, there is higher aircraft performance, and better crash survivability. In a method or corresponding apparatus, a system stores flight data for an aircraft in a primary node and stores substantially the same flight data in one or more secondary nodes. The one or more secondary nodes are located in the aircraft, but in a different location than the primary node so as to allow a backup redundancy of flight data. It is also useful to note that some locations are more beneficial for locating a flight data recorder (e.g., nodes) than others. Some example locations that are desirable include: wing tips, tail, near Emergency Locator Transmitters (ELT), a servo, or in radio frequency equipment that is typically shielded. These locations are desirable because they are more resilient to damage.

In embodiments, the primary node and the one or more secondary nodes are flight data recorders and are also made of more durable material. Each of the flight data recorders store flight data parameters (values thereof), such as time, pressure altitude, airspeed, vertical acceleration, magnetic heading, control-column position, rudder pedal position, control-wheel position, horizontal stabilizer, fuel flow, or other data relating to the aircraft.

In an embodiment, a primary node (e.g., FDR) and the one or more secondary nodes (e.g., multiple FDRs) use storage nodes on an internal aircraft data bus or network. Thus, the primary and the one or more secondary nodes are configured to collect the flight data using existing network nodes in the aircraft and as such record the flight data using existing nodes in the aircraft. An added benefit to using existing nodes is the primary node and the one or more secondary nodes store flight data without an increase in weight to the aircraft. A further benefit includes a lower cost by repurposing spare capacity in existing avionics nodes for storing flight data and, in turn, not purchasing dedicated equipment. Moreover, the aircraft maintains a higher performance because of the weight and energy consumption savings resulting from not using a dedicated flight data recorder system.

In an embodiment, a user (e.g., typically an operator) obtains the flight data from the primary node or the one or more secondary nodes. By storing substantially the same flight data in each of the FDRs (e.g., the primary node and the one or more secondary nodes) the data is available in multiple locations. A system using principles of the present invention duplicates the data by: making multiple copies, using parity storage, forwarding error correction encoding, or other suitable process.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows an aircraft using a single FDR;

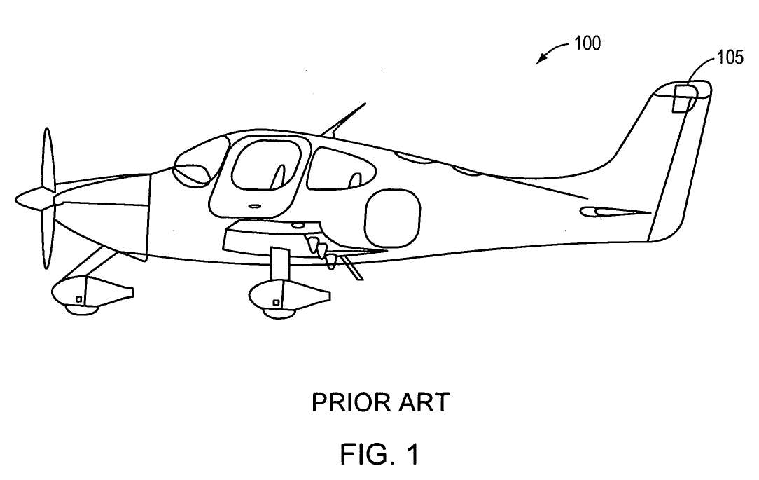

FIG. 2 shows a side-view of an aircraft having multiple FDRs in accordance with an embodiment of the present invention;

FIG. 3A shows a top-view of an aircraft having multiple FDRs in accordance with an embodiment of the present invention;

FIG. 3B shows FDRs within inter-connected blade servers in accordance with embodiments of the present invention;

FIG. 4A is a block diagram depicting example components of a blade server in accordance with an embodiment of the present invention;

FIG. 4B is a block diagram depicting an example network bridge for communicating with multiple blade servers in accordance with an embodiment of the present invention; and

FIG. 5 is a block diagram depicting an example flight data recorder and components in accordance with embodiments of the present invention.

### DETAILED DESCRIPTION OF THE INVENTION

A description of example embodiments of the invention follows.

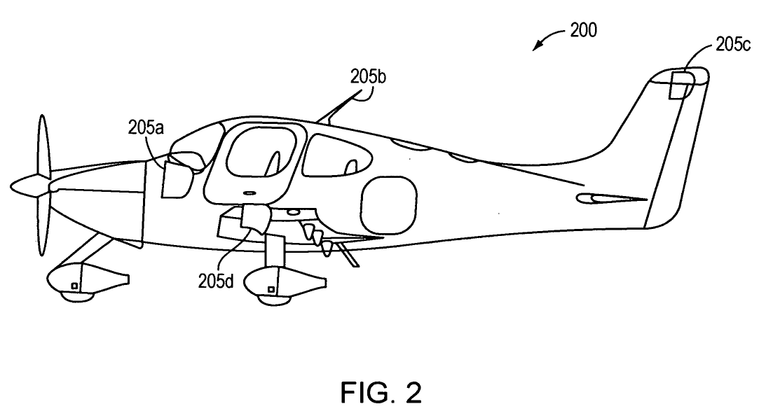

FIG. 2 shows a side view of an aircraft 200 having multiple Flight Data Recorders (FDRs) in accordance with an example embodiment of the present invention. Specifically, the aircraft 200 includes multiple FDRs 205a-205d, where FDR 205a is a primary node and the remaining FDRs 205b-205d are secondary nodes. Each of these nodes store substantially the same flight data for later review. It should be understood that any FDR may be designated as the primary node. Further, any number of FDRs may be used in accordance with the principles of the present invention. Moreover, as the number of FDRs increases, the ability to retrieve crash data also increases by virtue of having more backup/redundancy nodes for storing flight data.

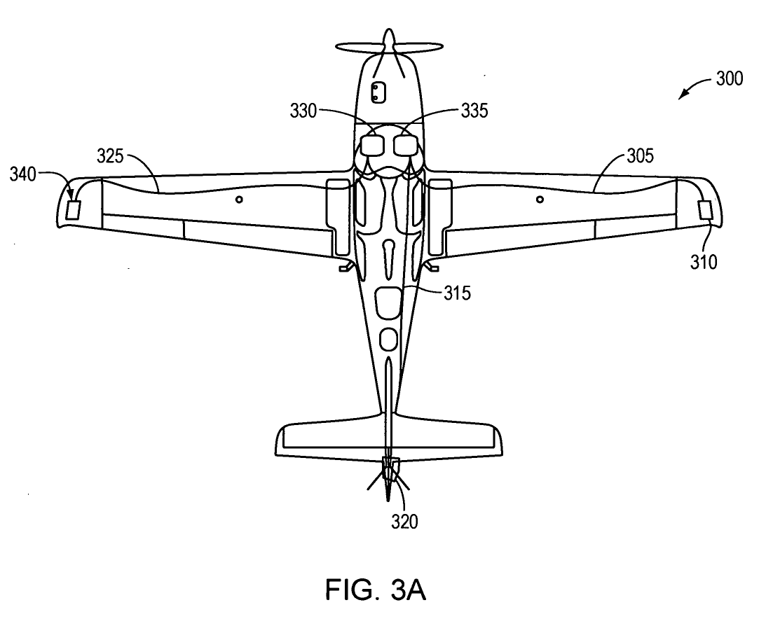

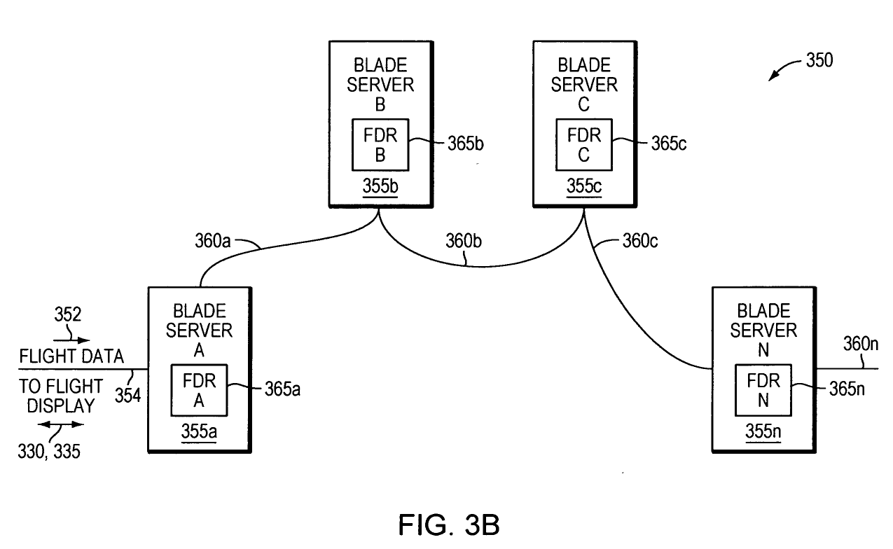

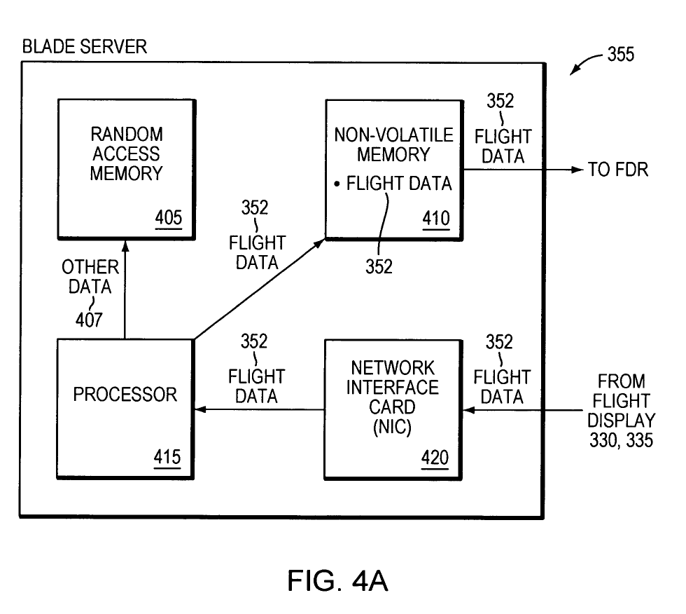

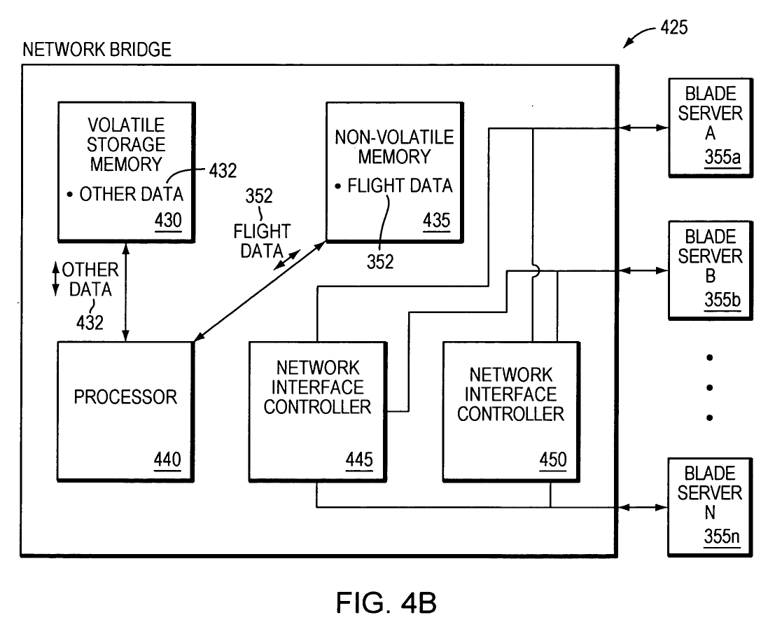

FIG. 3A shows a top-view of an aircraft having multiple FDRs in accordance with an embodiment of the present invention. For example, an aircraft 300 includes flight displays 330 and 335 communicating over communications wires 305, 315, and 325, respectively with memory storage units 310, 320, and 340. A flight display 330, 335 provides flight information, such as an attitude indicator or the aircraft's future path, to the memory storage units 310, 320, and 340. For example, a flight display, such as 330 or 335, obtains information regarding the aircraft's future path. In turn, a system employing principles of the present invention transmits data indicative of the aircraft's future path over communications wires 305, 315, or 325 as appropriate to a memory storage unit, such as 310, 320, or 340. As a result of the transmission, the memory storage unit 310, 320, or 340 stores the data pertaining to the aircraft's future path (e.g., flight data) for use by an operator in the event of an accident or incident. To lessen risk of damage from an accident or incident, some memory storage units (e.g., memory storage units 310, 320, and 340) are placed in extremities of the aircraft fuselage and wings. It is useful to note that embodiments of the present invention can operate independent of the location of the memory storage units 310, 320, and 340. Should an accident or incident occur, the operator can better understand the conditions and parameters of the flight at the time of the accident or incident. It should be understood that the above is merely an example and that any flight data can be passed between the flight displays 330 and 335 and memory storage units 310, 320, 340. It should also be understood that a memory storage unit can be a FDR or a FDR as part of a blade server as described in FIG. 4A.

FIG. 3B shows FDRs within inter-connected blade servers in accordance with embodiments of the present invention. In an embodiment, an aircraft includes a network 350 of nodes, having blade servers A-N (355a-n, generally 355). Each blade server 355a-n is inter-connected in such a way as to allow each blade server to communicate flight data 352 between servers. In operation, a flight display 330, 335 transmits flight data 352 over a communications path 354 to blade server A 355a (e.g., a primary node). After receiving the flight data 352, the blade server A 355a transmits the flight data 352 over communications paths 360a-360n to respective blade servers B-N 355b-n using a network bridge as seen in FIG. 4B. In this way, each of the blade servers A-N 355a-n contain the most recent flight data 352 sent from the flight display 330, 335. Once the blade servers A-N 355a-n receive the flight data 352, the blade servers A-N 355a-n store the flight data 352 in memory of the associated FDR A-N 365a-n (generally 365) for later review by an operator (if appropriate). As a result, an operator can obtain flight data 352 from one or more FDRs A-N 365a-n in the event any FDR 365 is damaged beyond repair.

It should be understood that embodiments of the present invention may use any network node or server and is not limited to using a blade server. It should be further understood that FDRs A-N 365a-n may be located outside of the blade server, network nodes, or server. It is, however, advantageous to place the FDRs A-N 365a-n within a blade server as the FDRs 365a-n may use the common power sources, battery backup, and other existing components of the blade server features.

FIG. 4A is a block diagram depicting example components of a blade server 355. In an embodiment, a blade server 400 (or other avionics computing unit/network node) includes Random Access Memory (RAM) 405, a non-volatile memory 410, a processor 415, and Network Interface Controller (NIC) 420. The blade server 400 is typically a self-contained computer server designed for high density usage. Generally the blade server 400 has many components removed for the benefit of space, power, and other considerations and yet still has the features and components of a computer. For example, the blade server 400 enclosure provides services such as power, cooling, networking, various interconnects, and management, which embodiments of the present invention leverage by having a FDR use these existing features and components. It is useful to note that in a standard blade server configuration, one component (e.g., one rack unit) is the minimum possible size of any equipment. However, the blade server is expandable to densities of at least one hundred computers per rack. In this way, the blade servers easily facilitate many components (e.g., easy expansion of the number of FDRs). It should be noted that in some embodiments, a dedicated flight data recorder server or a hybrid between the blade server and flight data recorder server may be employed for processing flight data.

In operation, a blade server 400 receives flight data 352 from a flight display 330, 335 and transmits the flight data 352 to a FDR. More specifically, the processor 415 receives the flight data 352 from a flight display via a Network Interface Controller (NIC) 420. The processor 415, in turn, forwards the flight data 352 to a non-volatile memory 410 and forwards any other data 407 to Random Access Memory 405 to facilitate processing. Once the non-volatile memory 410 obtains the flight data 352, the non-volatile memory 410 forwards the flight data 352 to at least one FDR (e.g., the non-volatile memory 410 may forward to multiple FDR) for storage. The volatile memory can be used for data that is not as useful to an operator. It is useful to note that non-volatile memory describes random access memory that does not lose the contents of the memory when power is lost. This is in contrast to most forms of random access memory today, such as RAM, which use continual power in order to maintain their data. Thus, non-volatile memory 410 provides the benefit of continuing to store flight data 352 even after an accident or incident causes a power loss.

FIG. 4B is a block diagram depicting an example network bridge 425 for communicating with multiple blade servers 355a-n in accordance with an embodiment of the present invention. In operation, a network bridge 425 connects multiple network nodes, such as blade servers A-N 355a-n, at the data link layer. Network bridges do not, however, copy traffic to each port instead network bridges use network interface controllers, such as 445, 450 to learn a forwarding MAC address. Once the network bridge 425 learns a forwarding address, the network bridge 425 sends traffic for that address to that port. This aides in efficient processing and sending flight data to the correct locations. It is useful to note that network bridges can learn the association of ports and addresses by examining the source address of frames that it sees on various ports. Once a frame arrives through a port, its source address is stored and the bridge assumes that MAC address of a NIC is associated with that port. The first time that a previously unknown destination address is seen, the bridge will forward the frame to all ports other than the one on which the frame arrived. In this way, a network bridge 425 employing principles of the present invention transmit flight data 352 to multiple locations for backup.

For example, a network bridge 425 connects to one or more blade servers A-N 355a-355n for transmitting data between networks. The network bridge 425 includes a volatile storage memory 430, a non-volatile memory 435, a processor 440, and a plurality of Network Interface Controllers (NIC) 445, 450. In use, the network bridge 425 transmits flight data 352 and other data 432 via the processor 440 to one or more network interface controllers 445, 450 where a forwarding address is learned. The respective network interface controller 445, 450 forwards the flight data 352 and other data 432 (if desired) to one or more blade servers A-N 355a-355n in other networks. In this way, the one or more blade servers A-N 355a-355n stores the flight data 352 and other data 432 resulting in redundancy of flight data 352 and better crash survivability. The one or more blade servers, including primary and secondary nodes store substantially the same flight data by making multiple copies, using parity storage, using a forward error correction encoding, or using an other suitable backup. In an alternative embodiment, a network bridge 425 includes one or more blade servers A-N 355a-355n within the same network or use a second network having a second network bridge and one or more blade servers. It should be understood that embodiments of the present invention may also use mirroring, RAID arrays, or other such technique to create multiple copies of flight data.

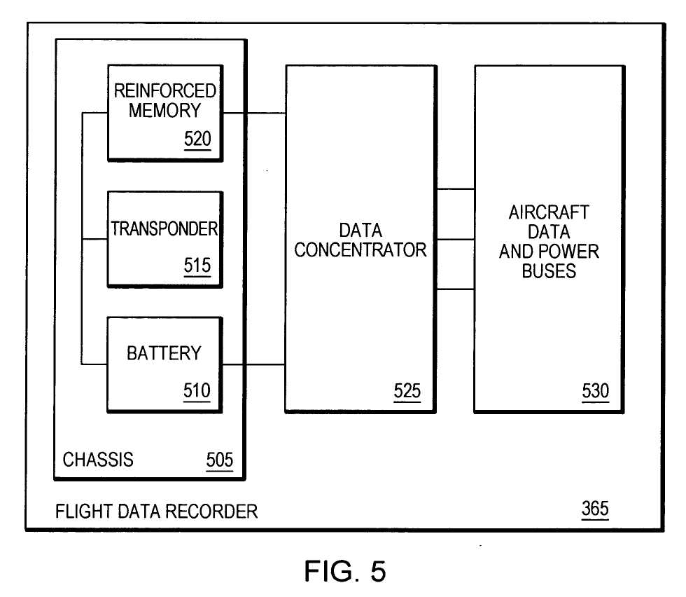

FIG. 5 is a block diagram depicting an example flight data recorder 500 and components in accordance with an embodiment of the present invention. In particular, FIG. 5 shows components of a Flight Data Recorder 365. A chassis 505 (generally hardened) connects to a data concentrator 525 that receives flight data from one or more sensors or avionics aircraft systems, such as a blade server 355. The chassis 505 may also include a reinforced memory 520 (for additional prevention against damage), a location transponder 515 (to facilitate an operator to find the flight data recorder 365 in case of an accident/crash in remote location), and battery 510 which supplies operating current to the location transponder 515.

Further, the data concentrator 525 may also receive flight data from the aircraft data and power buses 530. For example, the data concentrator 525 receives flight data from a flight display (or the aircraft data and power buses 530) and also receives air pressure from a pressure sensor. From this data, an operator can obtain a greater understanding of the conditions should an accident, crash, or incident occur. It should be understood that the aircraft data and power buses 530 may also be located external to the flight data recorder 365 (e.g., in a blade server 355).

In general, FDRs 365 are created in such a way as to allow durability (e.g., by using durable material). For example, a typical FDR may be double wrapped, in strong corrosion-resistant titanium or stainless steel and include high-temperature insulation inside. In other examples, the FDR may use three layers of materials, an aluminum housing (e.g., a thin layer of aluminum around the stack of memory cards), a high-temperature insulation (e.g., high-temperature thermal protection), and a titanium or stainless-steel shell (e.g., a stainless-steel cast shell that is about 0.25 inches thick). In this way, FDRs are extremely reliable and durable during use with an aircraft.

Another factor relating to FDRs is regulations. For example, regulations also require FDRs to store particular information, known as parameters (values thereof), of an aircraft during flight. Some useful parameters include: time, pressure altitude, airspeed, vertical acceleration, magnetic heading, control-column position, rudder pedal position, control-wheel position, horizontal stabilizer, fuel flow, or other flight data relating to the aircraft. Recorded/stored values of these parameters are used by operators after a crash. In particular, an operator downloads the recorded parameter values from the FDR and attempts to recreate the events of the crash. This process can take weeks or months to complete. If the FDR is not damaged, investigators can simply play back the recording by connecting the FDR to a readout system. With solid-state recorders, investigators can extract stored data in a matter of minutes. Very often, recorders retrieved from wreckage are dented or burned. In these cases, the memory boards are removed, cleaned up and a new memory interface cable is installed. Then the memory board is connected to a working recorder. This creates the problem of time delays, which having multiple FDRs resolves.

Once the flight data is retrieved from the FDR, the Safety Board can generate a computer animated video reconstruction of the flight. The investigator can then visualize the airplane's attitude, instrument readings, power settings, and other characteristics of the flight. This animation enables the investigating team to visualize the last moments of the flight (aircraft) before the accident. The FDR is an invaluable tool for any aircraft investigation. The FDR can be a lone survivor of an airplane accident, and as such provides important clues to the cause that would be impossible to obtain any other way. As technology evolves, FDRs will continue to play a role in accident investigations. Having multiple FDRs increases the chances an operator can have the data without undue time delay.

It should be understood that the principles of the present invention can apply not only to aircraft, but also to any vehicle, train, flight vehicle, or mode of transportation with a risk of accident or incident. The equivalent of a Flight Data Recorder (FDR) in any such vehicle would be configured for redundant storage of working data (e.g., flight data) by the principals of the present invention given the foregoing.

While this invention has been particularly shown and described with references to example embodiments thereof, it will be understood by those skilled in the art that various changes in form and details may be made therein without departing from the scope of the invention encompassed by the appended claims.

For example, an embodiment of the present invention stores flight data for an aircraft in a collaborative system, such as a peer to peer network instead of a primary node and one or more secondary nodes. Thus, the collaborative system is capable of storing, transmitting, and receiving flight/event data without a primary node.

Another example is reconstituting data from one or more surviving plurality of nodes containing partial data of an event. An embodiment of the present invention merges the partial data from one or more plurality of nodes with at least one other node to provide an operator with the details of the full event (e.g., from data from multiple nodes). In one embodiment, a system uses dovetailing to time stamp recorded data in each node, thus facilitating the reconstitution of event data from partial data. In another embodiment, one or more nodes stores a subset of the event data. Storing a subset of the event data in each node is particularly useful for using less storage space (e.g., when storage space is limited).

What is claimed is:

1. A system for storing flight data, comprising:
a primary node configured to store flight data of an aircraft; and
one or more secondary nodes configured to store flight data, where the one or more secondary nodes are located in a different location than the primary node; and the primary node and one or more secondary nodes are located in existing network nodes in the aircraft.

2. A system as claimed in claim 1 wherein the primary node and the one or more secondary nodes are flight data recorders.

3. A system as claimed in claim 1 wherein the existing network nodes are on an internal aircraft data bus or network.

4. A system as claimed in claim I wherein the flight data includes parameters for a flight data recorder.

5. A system as claimed in claim 4 wherein the parameters include any one or combination of the following: time, pressure altitude, airspeed, vertical acceleration, magnetic heading, control-column position, rudder-pedal position, control-wheel position, horizontal stabilizer, fuel flow, or other data relating to the aircraft.

6. A system as claimed in claim 1 wherein a user obtains the flight data from the primary node or the one or more secondary nodes.

7. A system as claimed in claim 1 wherein the one or more secondary nodes stores substantially the same flight data by using one of the following: make multiple copies, use parity storage, forward error correction encoding, or other suitable backup.

8. A system as claimed in claim 1 wherein the primary node and the one or more secondary nodes stores flight data without an increase in weight to the aircraft.

9. A system as claimed in claim 1 wherein the primary and the one or more secondary nodes are configured to collect and record the flight data using existing nodes in the aircraft.

10. A method for storing flight data, comprising:
storing flight data for an aircraft in a primary node; and
storing substantially the same flight data in one or more secondary nodes, where the one or more secondary nodes are in the aircraft and in a different location than the primary node so as to allow a backup of the flight data.

11. A method as claimed in claim 10 wherein the primary node and the one or more secondary nodes are flight data recorders.

12. A method as claimed in claim 10 wherein the flight data includes parameters for a flight data recorder.

13. A method as claimed in claim 12 wherein the parameters include one of the following: time, pressure altitude, airspeed, vertical acceleration, magnetic heading, control-column position, rudder-pedal position, control-wheel position, horizontal stabilizer, fuel flow, or other data relating to the aircraft.

14. A method as claimed in claim 10 wherein the primary node and the one or more secondary nodes uses existing nodes located on an internal aircraft data bus or network.

15. A method as claimed in claim 10 wherein a user obtains the flight data from the primary node or the one or more secondary nodes.

16. A method as claimed in claim 10 wherein the one or more secondary nodes stores substantially the same flight data by using one of the following: making multiple copies, using parity storage, forwarding error correction encoding, or other suitable backup.

17. A method as claimed in claim 10 wherein the primary node and the one or more secondary nodes stores flight data without an increase in weight to the aircraft.

18. A method as claimed in claim 10 further comprising the steps of:
collecting the flight data using existing nodes in the aircraft; and
recording the collected flight data using existing nodes in the aircraft.

19. A system for storing working data of a subject vehicle, comprising:
a primary node means configured to store working data of a subject vehicle; and
one or more secondary node means for storing the working data, the one or more secondary node means each being located in a different location than the primary node means, and the primary node means and the one or more secondary node means being located in existing network nodes in the subject vehicle.

20. A system as claimed in claim 19 wherein:
the primary node means and the one or more secondary node means are data recorders; and
the working data includes parameters recordable by data recorders including any one or combination of the following: time, pressure altitude, airspeed, vertical acceleration, magnetic heading, control-column position, rudder-pedal position, control-wheel position, horizontal stabilizer, fuel flow, or other data relating to the aircraft.
